(19) United States
(12) Patent Application Publication
(10) Pub. No.: US 2024/0376955 A1
(43) Pub. Date: Nov. 14, 2024

(54) ELECTRONIC VALVE INTERFACE

(71) Applicant: Fox Factory, Inc., Duluth, GA (US)

(72) Inventors: Tyler Eston, Solon, OH (US); Rick Strickland, Winder, GA (US); Sam Buller, San Diego, CA (US); Ivan Tong, Odenton, MD (US)

(73) Assignee: Fox Factory, Inc., Duluth, GA (US)

(21) Appl. No.: 18/615,888

(22) Filed: Mar. 25, 2024

Related U.S. Application Data
(60) Provisional application No. 63/454,908, filed on Mar. 27, 2023.

(51) Int. Cl. F16F 9/44; F16F 9/348

(52) U.S. Cl. CPC F16F 9/446; F16F 9/3488; F16F 2222/126; F16F 2226/04; F16F 2228/066; F16F 2230/186

(57) ABSTRACT

An electronic valve interface for a shock assembly is disclosed. The electronic valve interface includes a housing, an outlet cover shim stack land and a threaded housing barrel. An electronic valve with a main flow path within a portion of the housing. An outlet cover covering an outlet of the electronic valve. An outlet cover shim stack having a first cracking pressure and working in conjunction with the outlet cover to provide a pressure to a working fluid. A blow-off piston having a blow-off flow path. A blow-off shim stack having a second cracking pressure different from the first cracking pressure. A threaded retaining nut operating in conjunction with the outlet cover shim stack land to provide a single retaining force for the outlet cover shim stack, the blow-off shim stack, and the blow-off piston located axially on the threaded housing barrel, where the outlet cover shim stack and the blow-off shim stack are opposed directional shim stacks.

### CROSS-REFERENCE TO RELATED APPLICATIONS (PROVISIONAL)

This application claims priority to and the benefit of co-pending U.S. Provisional Patent Application No. 63/454,908 filed on Mar. 27, 2023, entitled “ELECTRONIC VALVE INTERFACE” by Tyler Eston et al., and assigned to the assignee of the present application, the disclosure of which is hereby incorporated by reference in its entirety.

### FIELD OF THE INVENTION

Embodiments of the invention generally relate to an electronically adjustable valve for a shock assembly.

### BACKGROUND

Shock assemblies are used in numerous different vehicles and configurations to absorb some or all of a movement that is received at a first portion of a vehicle before it is transmitted to a second portion of the vehicle. For example, when a front end of a vehicle hits a rough spot, the encounter will cause an impact force on the vehicle. By utilizing suspension components including one or more shock assemblies, the impact force can be significantly reduced or even absorbed completely by the suspension before it is transmitted to a user operating the vehicle.

### BRIEF DESCRIPTION OF THE DRAWINGS

Aspects of the present invention are illustrated by way of example, and not by way of limitation, in the accompanying drawings, wherein:

FIG. 1 is a perspective view of a shock assembly, in accordance with an embodiment of the present invention.

FIG. 2 is a cross-section view of the top portion of the shock assembly of FIG. 1, in accordance with an embodiment of the present invention.

FIG. 3 is a cross-section view of a portion of an electronic valve interface, in accordance with an embodiment of the present invention.

FIG. 4 is a cross-section view of the electronic valve interface showing a number of flow paths, in accordance with an embodiment of the present invention.

FIG. 5 is a graph showing the low-speed high-flow performance of a number of different electronic valve interfaces including the electronic valve interface of FIG. 3, in accordance with an embodiment of the present invention.

FIG. 6 is a graph showing the low-speed high-flow performance and the lockout performance of the electronic valve interface of FIG. 3, in accordance with an embodiment of the present invention.

The drawings referred to in this description should be understood as not being drawn to scale except if specifically noted.

### DESCRIPTION OF EMBODIMENTS

The detailed description set forth below in connection with the appended drawings is intended as a description of various embodiments of the present invention and is not intended to represent the only embodiments in which the present invention is to be practiced. Each embodiment described in this disclosure is provided merely as an example or illustration of the present invention, and should not necessarily be construed as preferred or advantageous over other embodiments. In some instances, well known methods, procedures, and objects have not been described in detail as not to unnecessarily obscure aspects of the present disclosure.

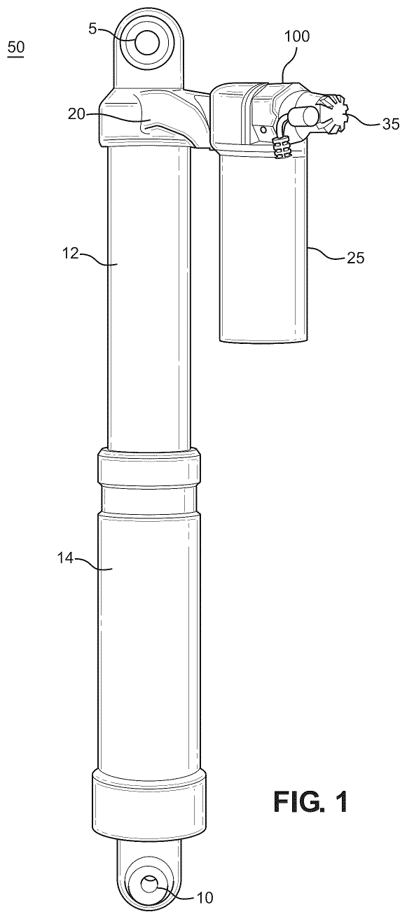

Referring now to FIG. 1, a perspective view of a shock assembly 50 is shown in accordance with an embodiment. In one embodiment, shock assembly 50 is a FOX load optimizing air technology (FLOAT) air shock assembly with a reservoir. In general, an air shock assembly is a high-performance shock assembly that use air as springs, instead of heavy steel coil springs or expensive titanium coil springs. Although in one embodiment the shock assembly 50 is described as an air shock style shock assembly. In another embodiment, the shock assembly 50 is a coil-over shock assembly, such as, for example, a FOX 2.0 zero QS3-R shock assembly with a velocity-sensitive shimmed damping system, one or more coil-over springs, a spring preload adjuster, and a reservoir. In another embodiment, the shock assembly 50 may be another type of shock assembly such as, but not limited to, a stand-alone fluid damper assembly, a coil sprung adjustable shock assembly, an air sprung fluid damper assembly, or the like.

In general, shock assembly 50 includes attachment features such as, in one embodiment, a chassis mount (e.g., upper eyelet 5) and a frame mount (e.g., lower eyelet 10) which allow shock assembly 50 to be coupled between the unsprung portion of the suspension (e.g., the components of the suspension affected by, or in contact with, the terrain) and the sprung portion.

In one embodiment, shock assembly 50 includes body 12, an expansion component (e.g., main air chamber 14) providing some type of expansive (or spring) force on shock assembly 50, and a main air valve 324 for adding or removing air from main air chamber 14. In one embodiment, the shock assembly 50 also includes body cap 20, and a reservoir 25 fluidly coupled with the body 12.

A configuration of an external and/or side reservoir, including a floating piston, is described in U.S. Pat. No. 7,374,028 the content of which is incorporated by reference herein, in its entirety. Moreover, in various embodiments of the present invention, the electronic valve interface may be used in active valve suspensions and components, to include base valves, compression valves, rebound valves, and the like. Embodiments of different active valve suspension and components where the electronic valve interface may be utilized are disclosed in U.S. Pat. Nos. 8,838,335; 9,353,818; 9,682,604; 9,797,467; 10,036,443; 10,415,662; the content of which are incorporated by reference herein, in their entirety.

In one embodiment, shock assembly 50 includes an adjustable rebound damping valve 35. In one embodiment, the components shown as being associated with shock assembly 50 may also be included in one or more other active and/or semi-active shock assemblies of a vehicle upon which shock assembly 50 is coupled.

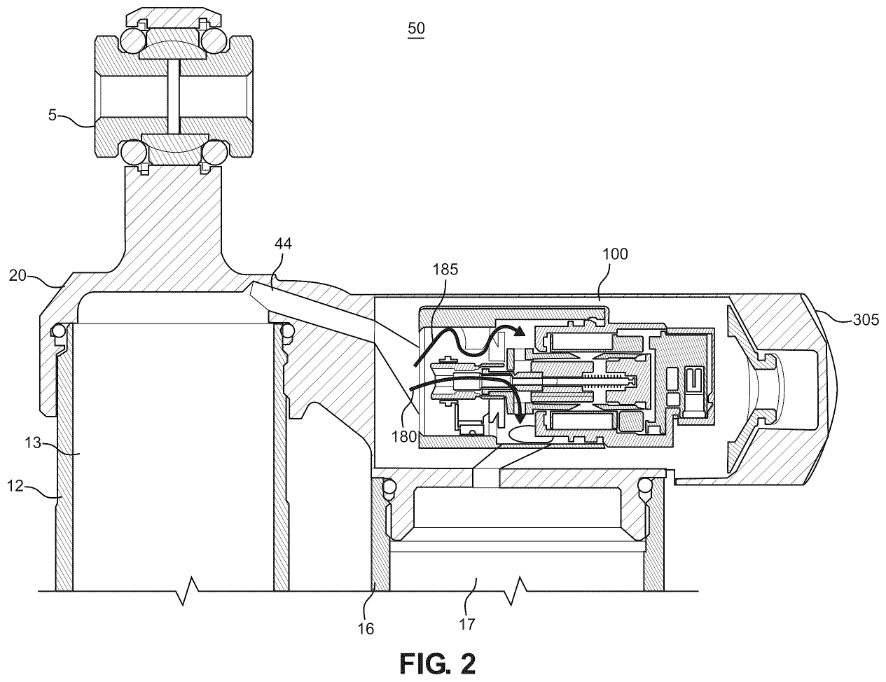

Referring now to FIG. 2, a cross-section view of the top portion of the shock assembly 50 of FIG. 1 is shown in accordance with an embodiment. In one embodiment, the cross-sectional view shows a portion of the chamber 13 of body 12 that holds the working fluid, a portion of the reservoir chamber 17 of reservoir 25 that holds the working fluid, and the flow path 44 in the body cap 20 therebetween. In addition, the electronic valve interface 100 for controlling the flow rate is shown within flow path 44 between chamber 13 and reservoir chamber 17.

In one embodiment, main air chamber 14 provides some type of expansive (or spring) force on shock assembly 50. In one embodiment, shock assembly 50 includes a piston coupled with a piston shaft, where the piston is located somewhere within the internal chamber 13 of body 12. In one embodiment, when installed, the resting length of the mounted shock assembly 50 is maintained in compression by the weight of the body it is suspending (e.g., the sprung portion of the vehicle), and in expansion by the “spring” force produced by the expansion component (e.g., main air chamber 14).

In one embodiment, reservoir 25 is fluidly coupled with the body 12 via a flow path(s) 44 through body cap 20. In one embodiment, the reservoir 25 has a reservoir chamber 17 that is divided by an internal floating piston (IFP). In one embodiment, one side of the IFP divided reservoir chamber 17 is filled with a pressurized gas (e.g., nitrogen, or the like) and the other side of reservoir chamber 17 is fluidly coupled with chamber 13 of body 12 via flow path 44 and contains working fluid. In general, the IFP keeps the pressurized gas from mixing with the working fluid and/or reaching the flow path 44.

In operation, when the vehicle encounters a bump, shock assembly 50 is compressed causing the piston and piston shaft to move further into chamber 13 of body 12 (e.g., the compression stroke). After the compression stroke, the expansion component (e.g., main air chamber 14) which was compressed by body 12 moving thereinto, acts to push body 12 back out of the main air chamber 14, causing the piston and piston shaft to move back toward their original location within the chamber 13 of body 12 (e.g., the rebound stroke).

During the compression stroke, some of the working fluid in chamber 13 of body 12 is displaced (due to the reduced volume within chamber 13 of body 12 caused by the incursion of the piston shaft). This displaced working fluid will flow from chamber 13 of body 12 through the flow path 44 in the body cap 20 to the reservoir chamber 17. As the working fluid fills the reservoir chamber 17, it will cause the IFP to move further into reservoir chamber 17 causing the pressurized gas to be further compressed, and in so doing, ensure consistent, fade-free damping in most riding conditions.

Often, the softer (or softest) setting for a shock assembly is desired or utilized when a vehicle is traversing a relatively smooth surface. For example, when a vehicle traveling down a well-maintained paved road it is common to have the shock assembly set to softest compression setting.

In general, when the electronic valve 105 is in a softest setting the working fluid can flow nearly unencumbered through the flow paths (such as main flow path 180) of electronic valve 105. That is, the flow paths of electronic valve 105 would be at their open and less-restrictive settings such that the working fluid would readily flow therethrough. This type of setting (e.g., a soft setting) allows the most fluid flow at a lower (or lowest) pressure and therefore provides a least restricted movement of the operation of shock assembly 50, thereby resulting in a smooth ride.

However, even when shock assembly 50 is at a soft setting and traveling on a well-maintained paved road, the shock assembly 50 is still be operating (e.g., compressing and rebounding) as the vehicle encounters even slight terrain variations and/or changes in the operation of the vehicle.

In one embodiment, as the fluid flow increases in a low-pressure environment, cavitation can occur. In general, cavitation occurs when the working fluid's local pressure drops below its saturated vapor pressure and the result is a shock assembly that no longer functions properly. Instead, the mixture of liquid and gaseous working fluid will deleteriously affect the operation of shock assembly 50.

In one embodiment, the electronic valve interface 100 is located in the body cap 20 flow path 44 between the chamber 13 of body 12 and the reservoir 25. In one embodiment, electronic valve interface 100 is used to control the flow rate of the working fluid through the flow path 44 during the compression stroke. Thus, making an adjustment to the electronic valve interface 100 will change the flow rate of the working fluid flowing through flow path 44 causing a corollary adjustment of one or more damping characteristics of the shock assembly 50 during the compression stroke.

In one embodiment, electronic valve interface 100 receives adjustment input(s) from user interface 205. In one embodiment, electronic valve interface 100 receives adjustment input(s) from a compression adjuster knob 305. In one embodiment, electronic valve interface 100 receives adjustment input(s) from user interface 205 and compression adjuster knob 305.

In one embodiment, the electronic valve interface 100 is electronically actuated. In one embodiment, the electronic valve interface 100 is mechanically actuated. In another embodiment, the electronic valve interface 100 is both mechanically and electronically actuated.

In one embodiment, electronic valve interface 100 includes a wired communication capability. For example, in one embodiment, electronic valve interface 100 receives adjustment inputs over a wired connection. In one embodiment, electronic valve interface 100 includes a wireless communication capability. For example, in one embodiment, electronic valve interface 100 receives adjustment input(s) via a wireless connection.

In one embodiment, electronic valve interface 100 and user interface 205 use a communication protocol such as, but not limited to, those disclosed in the communication protocol section herein. In one embodiment, the electronic valve interface 100 uses small and light componentry with a focus on both the minimizing of power requirements resulting in a long battery life and the minimizing of the weight/rotational inertia of the electronic valve interface.

Moreover, although components of FIGS. 1 and 2, are shown in given locations in accordance with one embodiment, in other embodiments, one, some, or all of the components shown in FIGS. 1 and 2 could be located in other locations, one or more components could be separated into two or more pieces and dispersed, etc. The use of the locations of the components as shown in FIGS. 1 and 2 are indicative of one embodiment, which is provided for purposes of clarity.

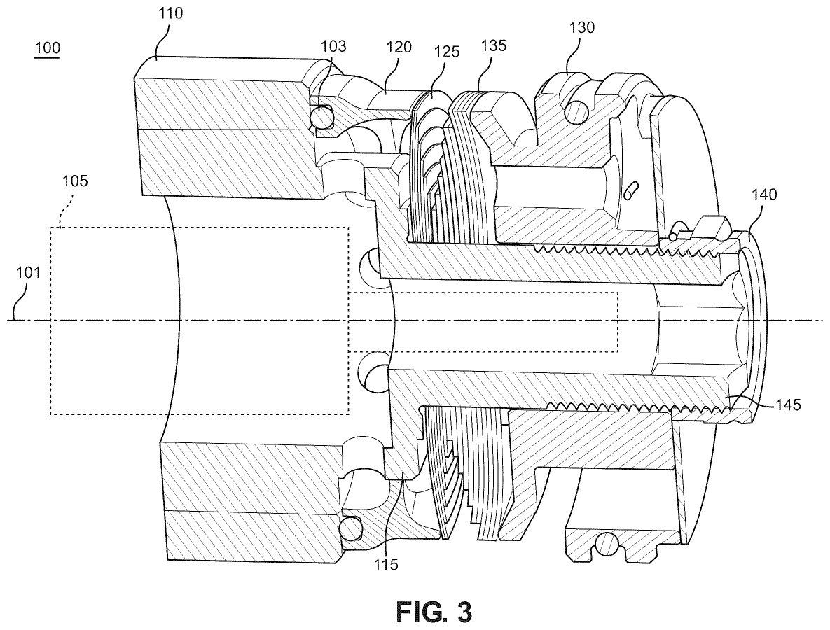

Referring now to FIG. 3, a cross-section view of electronic valve interface 100 is shown in accordance with an embodiment. In one embodiment, electronic valve interface 100 includes electronic valve 105, housing 110, threaded housing barrel 145, O-ring 103, outlet cover 120, outlet cover shim stack land 115, outlet cover shim stack 125, blow-off shim stack 135, blow-off piston 130, and threaded retaining nut 140. In one embodiment, an axis 101 is shown for purposes of clarity. In one embodiment, axis 101 is parallel to threaded housing barrel 145.

In one embodiment, the present electronic valve interface 100 is agnostic to the type of electronic valve 105 component. In general, instead of (or in addition to) restricting the flow through an orifice, electronic valve 105 can vary a flow rate through an inlet or outlet passage within the electronic valve 105, itself. In other words, the electronic valve 105 (or active valve), can be used to meter the working fluid flow (e.g., control the rate of working fluid flow) with/or without adjusting the flow rate through an orifice. Additional information regarding active and semi-active valves, including those used for compression and/or rebound stiffness adjustments, preload adjustments, bottom-out control, preload adjustment, ride height adjustment, can be found in U.S. Pat. Nos. 9,353,818 and 9,623,716 the content of which are incorporated by reference herein, in their entirety.

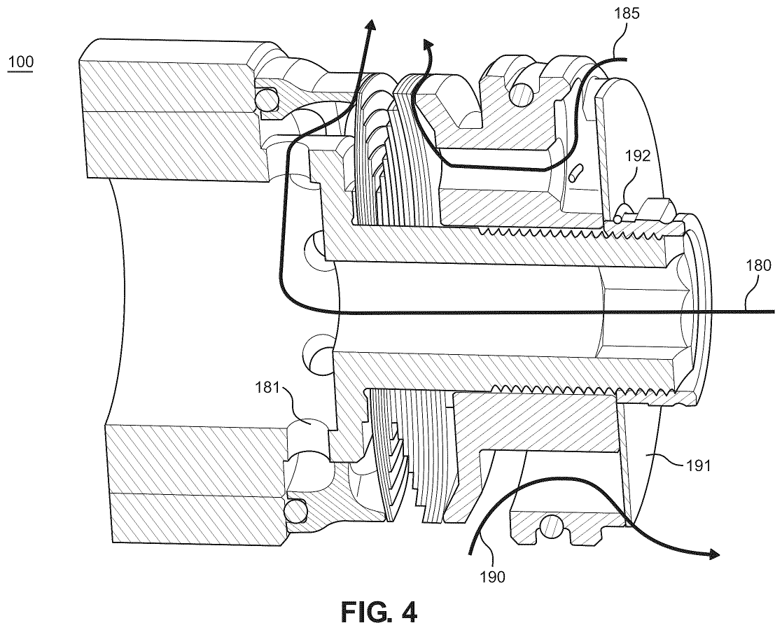

With reference now to FIG. 4, a cross-section view of electronic valve interface 100 showing a number of flow paths is shown in accordance with an embodiment.

In one embodiment, there are three flow paths: a main flow path 180, a blow-off flow path 185 and a check flow path 190. However, it should be appreciated that other embodiments may include more or fewer flow paths. The use of three flow paths is provided as one embodiment and for purposes of clarity.

Main flow path 180 indicates the flow path controlled by electronic valve 105. In general, the inlet flow of main flow path 180 is through the axial fluid pathway shown in the right in FIG. 4. The working fluid then flows through electronic valve 105. The outlet is through the radial holes 181.

In one embodiment, blow-off flow path 185 is a second (parallel) flow path that bypasses (or goes around) the main flow path of electronic valve 105. In one embodiment, blow-off flow path 185 includes a passive blow-off shim stack 135 that drives the firm (or lockout) setting for shock assembly 50. In one embodiment, flow through the blow-off flow path 185 is non-adjustable. In one embodiment, fluid flow through blow-off flow path 185 occurs only when fluid pressure reaches a level considered potentially harmful to the electronic valve 105 or other components of shock assembly 50. In such embodiments, shim stack 135 functions as a blow-off valve.

In one embodiment, a checked flow path 190 is provided. In such an embodiment, checked flow path 190 includes a check shim 191 with a conical spring 192. In general, the fluid flows back through checked flow path 190 relatively freely, e.g., without restriction.

Referring now to FIGS. 3 and 4, in one embodiment, electronic valve interface 100 is well suited to being used in combination with any new or legacy (e.g., a currently existing) version of an electronic valve 105. In so doing, in various embodiments of the present electronic valve interface 100, the outlet cover 120, outlet cover shim stack 151 and/or other components of electronic valve interface 100 will modify and/or tune the damping performance of the shock assembly to reduce and/or remove cavitation in the working fluid at low speed events when, for example, electronic valve 105 is in a softest setting.

In one embodiment, outlet cover 120 has a radially symmetric land with a number of shims in the outlet cover shim stack 125. In one embodiment, the radially symmetric land can be tuned to provide a preload against the shims of outlet cover shim stack 125 or to provide no preload against the shims of outlet cover shim stack 125.

Referring still to FIGS. 3 and 4, the shims of outlet cover shim stack 125 and the shims of blow-off shim stack 135 are mounted on the same axis 101 to provide a compact system. In one embodiment, there is a common pressure point to maintain both shim stacks. For example, in one embodiment, the two shim stacks (e.g., outlet cover shim stack 125 and blow-off shim stack 135) are clamped along the threaded housing barrel 145. For example, in one embodiment, housing 110 includes outlet cover shim stack land 115 and the outlet cover shim stack 125 is pressed against a portion thereof. Blow-off shim stack 135 is then pressed against outlet cover shim stack 125. Blow-off piston 130 is then pressed against blow-off shim stack 135. Finally, threaded retaining nut 140 is threaded onto threaded housing barrel 145 thereby providing a force against blow-off piston 130 and thus the entire system.

In embodiments of the present invention, even though outlet cover shim stack 125 and blow-off shim stack 135 are clamped along the threaded housing barrel 145 and both receive the same retaining force provided by threaded retaining nut 140, each of outlet cover shim stack 125 and blow-off shim stack 135 are independently controlled. That is, they may be set at different opening or crack pressures. Moreover, although they are clamped along the same threaded housing barrel 145 the working fluid flows in a right to left direction to move through blow-off shim stack 135 (e.g., a forward flow for purposes of clarity). In contrast, the working fluid flows in a left to right direction to move through outlet cover shim stack 125 (e.g., a reverse flow for purposes of the example).

Thus, in one embodiment, the two different shim stacks are used for independently controlling two different flow paths, which may or may not have two different cracking pressures while being mounted on the same threaded housing barrel 145 and receiving the same (i.e., a common) retaining force provided by threaded retaining nut 140. That is, via a single adjustment, threaded retaining nut 140 provides a common retaining force to each of outlet cover shim stack 125 and blow-off shim stack 135.

In one embodiment, the cracking pressures of each of the shim stacks is based on the rigidity of each of the two independent shim stacks.

In one embodiment, the outlet cover 120 is a piece that is separate from the electronic valve housing. For example, the outlet cover is coupled with (e.g., added to) the electronic valve housing 110 and hydraulically sealed to the electronic valve housing via the O-ring 103. In one embodiment, the outlet cover 120 is formed as part of the electronic valve housing 110, forgoing the need for the O-ring 103.

In one embodiment, the cracking pressures of one or both of outlet cover shim stack 125 and blow-off shim stack 135 can be adjusted by varying the diameter of the footprint of the shim stack. For example, the fluid pressure acting on the shim stack is adjustable based on the flat plate area of the shim that can be contacted by the working fluid. The smaller the flat plate area, the higher the cracking pressure. In one embodiment, changing the flat plate area of the shim that can be contacted by the working fluid is done by changing the location and interactive portion of the outlet cover 120 with respect to the outlet cover shim stack 125.

In one embodiment, the cracking pressure can also be tuned by adjusting the outer diameter (OD) or thickness of the deload shim (e.g., the innermost shim) to increase or reduce the fluid pressure required to open the flow path (e.g., the cracking pressure).

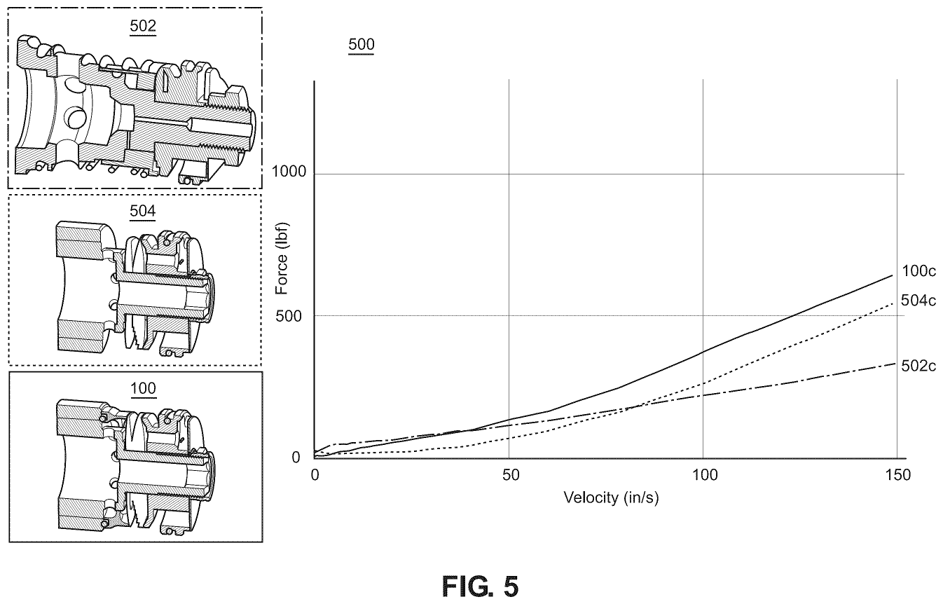

With reference now to FIG. 5, a graph 500 showing the low-speed high-flow (e.g., soft setting) performance of a number of different electronic valve interfaces including the electronic valve interface of FIG. 3 is shown in accordance with an embodiment. Graph 500 is a velocity (inches/second) versus force (ft-lb) analysis for the low-speed stroke of shock assembly 50 with a soft setting for a number of electronic valve interfaces including electronic valve interface 100.

In FIG. 5, the graph 500 shows the results of a velocity versus force analysis for three different electronic valve interfaces. Electronic valve interface 502 is an example of an existing electronic valve interface. Electronic valve interface 504 is an example of an electronic valve interface that includes the blow-off flow path 185. Electronic valve interface 100 is an example of the electronic valve interface that includes the blow-off flow path 185, the check flow path 190, the outlet cover 120 and the outlet cover shim stack 125 as the fluid leaves the outlet of the main flow path 180.

In one embodiment, while the graph 500 shows lighter forces (e.g., 0-150 ft-lb) being applied to shock assembly 50, it also shows the performance difference between the three different configurations.

In general, and as stated above, when the electronic valve 105 is in a softest setting the working fluid can flow nearly unencumbered through the flow paths (such as main flow path 180) of electronic valve 105. That is, the flow paths of electronic valve 105 would be at their open and less-restrictive settings such that the working fluid would readily flow therethrough. This type of setting (e.g., a soft setting) allows the most fluid flow at a lower (or lowest) pressure and therefore provides a least restricted movement of the operation of shock assembly 50 resulting in a smooth ride. As mentioned previously, as the fluid flow increases in a low-pressure environment, cavitation can occur. In general, cavitation occurs when the working fluid's local pressure drops below its saturated vapor pressure and the result is a shock assembly that no longer functions properly. Instead, the mixture of liquid and gaseous working fluid will deleteriously affect the operation of shock assembly 50.

An example of an existing electronic valve interface 502 operating in a soft position is shown by curve 502c of graph 500 of FIG. 5. As can be seen in curve 502c, the pressure on the working fluid remains low throughout the velocity range of 1-150 in/s.

Electronic valve interface 504 is an example of an electronic valve interface that includes the blow-off flow path 185 and a reduced axial length. As can be seen in curve 504c, the pressure on the working fluid below 80 in/s is less than that of the existing electronic valve interface 502. As such, the possibility of cavitation to occur is greater with respect to existing electronic valve interface 502 in this velocity range.

Electronic valve interface 100 is an example of the electronic valve interface that includes the reduced axial length, blow-off flow path 185, the check flow path 190, the outlet cover 120 and the outlet cover shim stack 125 as the fluid leaves the outlet of the main flow path 180. As can be seen in curve 100c, the pressure on the working fluid is generally higher than electronic interface 504 due to the implementation of the outlet cover 120 and the outlet cover shim stack 125. As such, the possibility for cavitation to occur is more reduced than that of either the existing electronic valve interface 504 or electronic valve interface 502 but at a reduced axial length.

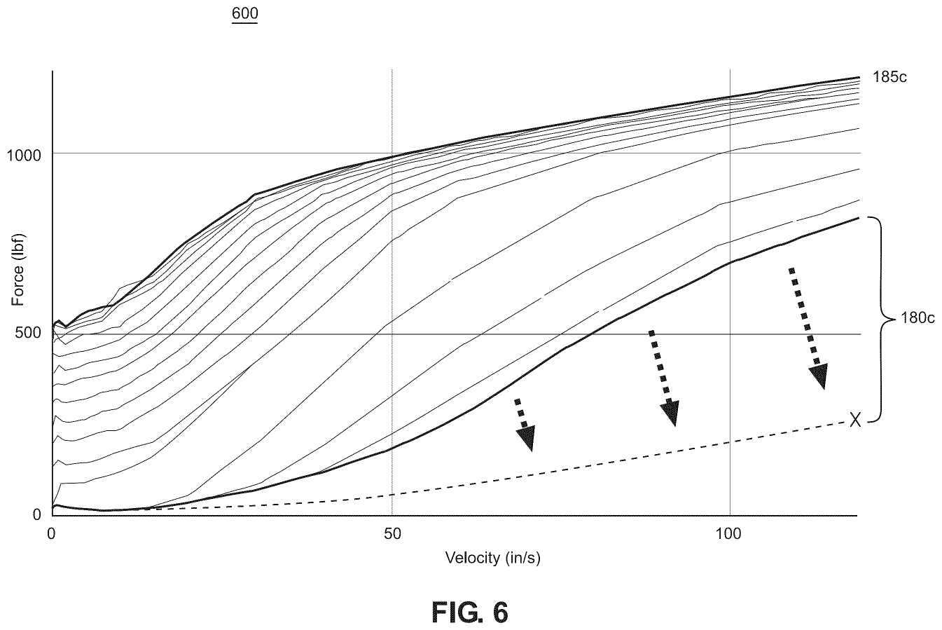

With reference now to FIG. 6, a graph 600 graph showing the low-speed high-flow performance and the lockout performance of the electronic valve interface 100 of FIG. 3 is shown in accordance with an embodiment. similar to graph 500, graph 600 is also a velocity (in inches/second) versus force (in ft-lb) analysis but this time for the low-speed performance of shock assembly 50 and also at lockout.

In general, line 180c shows an embodiment of the performance of low-speed compression and rebound strokes of shock assembly 50 when the electronic valve 105 is in a soft (or softest) compression state.

Line 185c shows an embodiment of the low-speed compression stroke of shock assembly 50 when the electronic valve interface 100 is placed in a lockout state.

The foregoing Description of Embodiments is not intended to be exhaustive or to limit the embodiments to the precise form described. Instead, example embodiments in this Description of Embodiments have been presented in order to enable persons of skill in the art to make and use embodiments of the described subject matter. Moreover, various embodiments have been described in various combinations. However, any two or more embodiments can be combined. Although some embodiments have been described in a language specific to structural features and/or methodological acts, it is to be understood that the subject matter defined in the appended claims is not necessarily limited to the specific features or acts described above. Rather, the specific features and acts described above are disclosed by way of illustration and as example forms of implementing the claims and their equivalents.

What is claimed is:

1. An electronic valve interface comprising:
a housing, said housing comprising:
an outlet cover shim stack land;
a threaded housing barrel; and
said housing configured to couple with an electronic valve, said electronic valve comprising a main flow path;
an outlet cover, said outlet cover configured to cover an outlet of said electronic valve;
an outlet cover shim stack located axially on said threaded housing barrel, said outlet cover shim stack comprising a first cracking pressure, said outlet cover shim stack operating in conjunction with said electronic valve to provide a pressure to a working fluid as it passes through said main flow path of said electronic valve;
a blow-off piston located axially on said threaded housing barrel, said blow-off piston comprising a blow-off flow path distinct from said main flow path of said electronic valve;
a blow-off shim stack located axially on said threaded housing barrel, said blow-off shim stack comprising a second cracking pressure greater than said first cracking pressure; and
a threaded retaining nut located axially on said threaded housing barrel, said threaded retaining nut to operate in conjunction with said outlet cover shim stack land to provide a single retaining force for each of said outlet cover shim stack, said blow-off shim stack, and said blow-off piston, where said outlet cover shim stack and said blow-off shim stack are opposed directional shim stacks.

2. The electronic valve interface of claim 1 wherein said outlet cover shim stack and said blow-off shim stack are individually tunable.

3. The electronic valve interface of claim 1 wherein said first cracking pressure of said outlet cover shim stack is configured to provide resistance to said working fluid at least when said electronic valve is in a least restrictive setting.

4. The electronic valve interface of claim 1 wherein said outlet cover shim stack has a radially symmetric land.

5. The electronic valve interface of claim 1 wherein said outlet cover shim stack has a radially symmetric contact area for said working fluid.

6. The electronic valve interface of claim 1 wherein said housing is integral with said electronic valve.

7. A valve assembly comprising:
an electronic valve, said electronic valve comprising:
a main flow path; and
an outlet; and
an electronic valve interface coupled with said electronic valve, said electronic valve interface comprising:
a housing, said housing comprising:
an outlet cover shim stack land; and
a threaded housing barrel;
an outlet cover, said outlet cover configured to cover said outlet of said electronic valve;
an outlet cover shim stack located axially on said threaded housing barrel, said outlet cover operating in conjunction with said electronic valve to provide a pressure to a working fluid as it passes through said main flow path of said electronic valve, said outlet cover shim stack having a first cracking pressure;
a blow-off piston located axially on said threaded housing barrel, said blow-off housing comprising a blow-off flow path distinct from said main flow path of said electronic valve;
a blow-off shim stack located axially on said threaded housing barrel, said blow-off shim stack comprising a second cracking pressure greater than said first cracking pressure; and
a threaded retaining nut located axially on said threaded housing barrel, said threaded retaining nut to operate in conjunction with said outlet cover shim stack land to provide a single retaining force for each of said outlet cover shim stack, said blow-off shim stack, and said blow-off piston, where said outlet cover shim stack and said blow-off shim stack are opposed directional shim stacks.

8. The valve assembly of claim 7 wherein said outlet cover shim stack is configured to increase resistance to said working fluid passing through said main flow path of said electronic valve at least when said electronic valve is in a least restrictive setting.

9. The valve assembly of claim 7 wherein said outlet cover shim stack and said blow-off shim stack are individually tunable.

10. The valve assembly of claim 7 wherein said outlet cover shim stack has a radially symmetric land.

11. The valve assembly of claim 7 wherein said outlet cover shim stack has a radially symmetric contact area for said working fluid.

12. The valve assembly of claim 7 wherein said electronic valve interface is integrated with said electronic valve.

13. The electronic valve interface of claim 7 wherein said electronic valve interface is removably coupleable with said electronic valve such that said electronic valve interface can be coupled with a legacy version of said electronic valve.

14. The electronic valve interface of claim 7 wherein said single retaining force is generated for each of said outlet cover shim stack and said blow-off shim stack via a clamp load from said threaded retaining nut.

15. The electronic valve interface of claim 7 wherein said first cracking pressure is configured to be tuned by adjusting a deload shim coupled with said outlet cover shim stack.

16. The electronic valve interface of claim 7 wherein said second cracking pressure is configured to be tuned by adjusting a deload shim coupled with said blow-off shim stack.

17. A method for increasing resistance to flow of a working fluid through a main flow path of an electronic valve when said electronic valve is in a least restrictive setting, said method comprising:
providing an electronic valve, said electronic valve including an outlet and a main flow path; and
providing an electronic valve interface for said electronic valve, said electronic valve interface comprising:
a housing, said housing comprising:
an outlet cover shim stack land; and
a threaded housing barrel;
an outlet cover, said outlet cover configured to cover said outlet of said electronic valve;
disposing an outlet cover shim stack located axially on said threaded housing barrel, said electronic valve interface operating in conjunction with said outlet cover to provide a resistance to a working fluid as it passes through said main flow path of said electronic valve;
disposing a blow-off piston axially on said threaded housing barrel, said blow-off housing comprising a blow-off flow path distinct from said main flow path of said electronic valve;
disposing a blow-off shim stack axially on said threaded housing barrel, said blow-off shim stack comprising a second cracking pressure greater than said first cracking pressure; and
providing a threaded retaining nut located axially on said threaded housing barrel, said threaded retaining nut to operate in conjunction with said outlet cover shim stack land.

18. The method for increasing resistance to flow of said working fluid through said main flow path of said electronic valve as recited in claim 17 further comprising:
configuring said outlet cover shim stack and said blow-off shim stack such that said outlet cover shim stack and said blow-off shim stack are individually tunable.

19. The method for increasing resistance to flow of said working fluid through said main flow path of said electronic valve as recited in claim 17 further comprising:
providing said outlet cover shim stack with a radially symmetric land.

20. The method for increasing resistance to flow of said working fluid through said main flow path of said electronic valve as recited in claim 17 further comprising:
providing said outlet cover shim stack with a radially symmetric contact area for said working fluid.

21. The method for increasing resistance to flow of said working fluid through said main flow path of said electronic valve as recited in claim 17 further comprising:
integrating said electronic valve interface with said electronic valve.

22. The method for increasing resistance to flow of said working fluid through said main flow path of said electronic valve as recited in claim 17 further comprising:
coupling said threaded retaining nut with said outlet cover shim stack land such that a single adjustment to said threaded retaining nut generates a single retaining force for each of said outlet cover shim stack and said blow-off shim stack.
